(19) United States
(12) Patent Application Publication
(10) Pub. No.: US 2013/0067330 A1
(43) Pub. Date: Mar. 14, 2013

(54) INFORMATION AND ENTERTAINMENT SYSTEM FOR VEHICLES

(71) Applicants: Kshirasagar Naik, Waterloo (CA); George Countryman, Kitchener (CA)

(72) Inventors: Kshirasagar Naik, Waterloo (CA); George Countryman, Kitchener (CA)

(21) Appl. No.: 13/615,109

(22) Filed: Sep. 13, 2012

Related U.S. Application Data
(60) Provisional application No. 61/533,969, filed on Sep. 13, 2011.

(51) Int. Cl. G06F 15/16; G06F 3/01

(52) U.S. Cl. 715/716

(57) ABSTRACT

An infotainment system for delivering media content to passengers of a multi-passenger vehicle, preferably a train, includes a plurality of personal computing devices having sufficient memory to accommodate a desired media volume. Media content files are stored on multiple supply servers and downloaded and stored directly on the personal computing devices via an at least one server located on board the vehicle. By storing the content on the personal computing devices themselves, vehicle passengers may view individually-selected media files according to the passenger's own preferences and timetable, without need for streaming from a central server. External servers located in close proximity to the vehicle, and in communication with the at least one on board server aid in facilitating and turnover of media files on the passenger devices and enhancing the overall efficiency of the system.

This application claims priority to U.S. Provisional Patent Application No. 61/533,969 filed on Sep. 13, 2011.

### FIELD OF THE INVENTION

The present invention relates generally to content delivery systems, and in particular to systems for delivering multimedia content to users via a wireless communication network.

### BACKGROUND OF THE INVENTION

Information and entertainment (i.e. infotainment) systems for delivering multimedia content to users of both public and private transportation, including multi-passenger vehicles, such as airplanes, cars, vans, or buses, or to persons present in waiting areas of transportation facilities, such as airports and railway stations, are known in the art. For example, in-flight infotainment systems are found on many airlines for use on their domestic and international routes. Generally, multimedia content is stored on on-board servers, and users access such content via seat-back mounted, touch screen-based devices. Different content will be updated at different time-points. For example, news content may be updated almost daily or hourly, whereas movies may be updated less frequently, such as monthly. While these sorts of content delivery systems are readily employed in the airline industry, the infotainment concept is relatively new for train travelers.

On-demand ITES (in-train entertainment system) systems of the prior art variety include an ITES system for providing on-demand TV service via seat-back screens of train passengers. Passengers can watch the latest TV shows, sports, and documentaries on screens similar in size to those found on commercial airplanes and multimedia contents are streamed to individual passenger devices on an on-demand basis from an on-board central server.

The most common use of infotainment in trains comes in the form of passenger information systems, wherein each train car is fitted with a digital display that shows passengers their current location and trip information, breaking news, local weather, and sports highlights.

Certain rail companies have installed, or are in the process of installing, wireless access points along railway tracks, for the purpose of facilitating complimentary WiFi service on-board trains and select train stations to allow passengers to remain productive while travelling. However, the use of such wireless access points as a means to deliver multimedia content to train passengers is unreliable as passengers are known to experience occasional connection outages on rail routes and data transmission speed can vary. This Wi-Fi service typically runs on a shared Internet connection that works best when browsing basic Internet content or e-mailing, and users may be asked to refrain from uploading or downloading large files. In addition, access to some websites may be restricted with a view to conserving bandwidth over certain peak periods for the purpose of ensuring a fair level of service to all users.

Existing passenger train infotainment systems generally fall into one of the following categories:

a. (C1) On-board server based systems: In these systems, content is stored on on-board severs on each train. User devices mounted on seat-backs do not store content. Rather, content is downloaded on an on-demand basis from the on-board server. The on-board server takes up space and requires significant operator attention, for example, for the purpose of performing system updates, uploading content, and providing system monitoring, and/or maintenance;
b. (C2) On-board Internet access systems: In these systems, users can connect their own wireless devices, namely laptops, smartphones and tablet computers, to the Internet via a shared WiFi connection. The WiFi connection from each user device to the Internet constitutes a bottleneck to performance. Accordingly, these systems cannot, for example, guarantee performance of multimedia applications requiring downloads of a large amount of data; and
c. (C3) Overhead information display systems: In this category of infotainment systems, information about local weather, sports highlights, and breaking news are shown in each car on wall mounted displays. Passengers have no control over the content presented on such displays.

As aforedescribed, existing train infotainment systems suffer from at least the following deficiencies: From a design perspective, owing to the nature of multimedia applications within the given operational environment: (i) these infotainment systems are required to handle tens of gigabytes of data; (ii) hundreds of users will be simultaneously accessing the infotainment system; (iii) the users are mobile; and (iv) the system is required to meet real-time constraints of the infotainment applications to provide a high quality experience to users. Therefore, it is a challenging task to design and deploy a low cost system that meets the real-time requirements of multimedia infotainment applications for users such as train passengers. From a management perspective, transportation operators generally do not employ sufficient resources for use in operating the infotainment system, and, particularly, to minimize the hardware needed onboard the train, monitoring the operational status (e.g. failed or functioning) of the various hardware elements of the system, and collecting data about the quantitative usage of multimedia contents and data about the satisfaction level of users, in order to deliver a better quality of experience to the users (for example, if certain content is determined to be rarely used, then that content should be substituted with different content, with a view to enhancing the user experience).

### SUMMARY OF THE INVENTION

The present invention generally relates to an infotainment system for use by a user in a vehicle, such as a train, comprising a plurality of individual computing devices, each computing device having sufficient memory to accommodate a desired media volume, and further comprising, an at least one server for downloading media to the individual computing devices, whereby the user at each computer device may view individually-selected media according to the user's own desires and timetable, without need for streaming from a central server.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is a schematic diagram illustrating the connection of multiple media servers and a train infotainment server to the Internet in accordance with the present invention.

FIG. 2 is a schematic diagram showing an organization of passenger devices and an on-board server (OBS) in each train car in accordance with the present invention.

FIG. 3 is a schematic diagram showing an organization of passenger devices and OBS on a multi-car train on a platform with train-side servers (TSS) in accordance with the present invention.

FIG. 4 is a schematic diagram displaying communication between passenger devices and a Train Infotainment Server (TIS) by means of TSS and OBS in accordance with the present invention.

FIG. 5 is a schematic diagram illustrating the main interactions among TIS and other media servers in accordance with the present invention.

FIG. 6 is a schematic diagram illustrating the main interactions among TIS, TSS, OBS, and passenger devices in a car in accordance with the present invention.

FIG. 7 is a schematic diagram showing the status management of passenger devices in accordance with the present invention.

FIG. 8 is a schematic diagram displaying the organization of passenger devices and OBS on a multi-car train with track-side access points (TSAP) in accordance with the present invention.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION

All terms used herein are used in accordance with their ordinary meanings unless the context or definition clearly indicates otherwise. Also, unless indicated otherwise except within the claims the use of “or” includes “and” and vice-versa. Non-limiting terms are not to be construed as limiting unless expressly stated or the context clearly indicates otherwise (for example, “including”, “having”, “characterized by” and “comprising” typically indicate “including without limitation”). Singular forms included in the claims such as “a”, “an” and “the” include the plural reference unless expressly stated or the context clearly indicates otherwise. Further, it will be appreciated by those skilled in the art that other variations of the preferred embodiments described below may also be practiced without departing from the scope of the invention.

The system of the present invention is particularly intended for use by train passengers, but can be readily adapted to use in other multi-passenger vehicles, such as aircraft, buses, or in waiting areas of facilities such as airports and railway stations. For convenience, trains will be referred to throughout this description, but it should be understood that the principles of the invention can be readily adapted to other environments.

The system of the present invention involves the storage of select media content on a device associated with each passenger (or user), such that the content can be accessed at the time of playing from the local storage on the device, rather than from a source outside the device. The system of the present invention takes advantage of the fact that certain media content is relatively static on hosted servers and it can take significant time (e.g. days or weeks) for this content to be changed over at its source (for example, some magazines are weekly and some are monthly, and a new movie release may be made available for a number of weeks). The infotainment system of the present invention takes advantage of the relatively static and slow change-over of the third party media content by including capabilities for storing this content on individual passenger devices. The system of the present invention also takes advantage of the fact that trains are often parked at stations for many hours every night. During this time, the system can download and store media contents on individual passenger devices.

By storing multimedia content on each passenger device, the invention responds to the problems identified in C1, C2, and C3 (above) as follows: The need for bulky servers in each car for real-time streaming of multimedia content to passenger devices is obviated, thereby reducing the need for operator assistance; Passengers receive constant high quality access to multimedia content, because the multimedia content is stored on the passenger devices themselves. Unlike the case C2, application quality does not degrade because the devices do not rely upon a wireless Internet connection to run applications, and the infotainment system of the present invention is interactive.

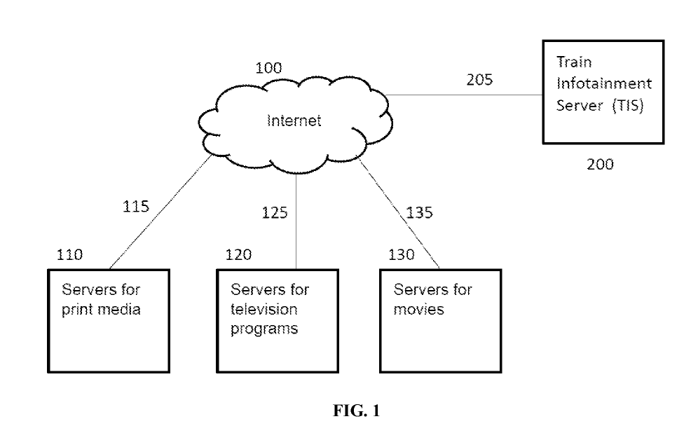

The system of the present invention involves delivering multimedia content (also known as media) to seat-mounted passenger devices on trains. Multimedia content may include, for example, magazines, movies, television programs, and video games in digital form. Different types of content are generally stored on one or multiple servers on the Internet. Users access the content via passenger devices, such as tablet computers. The tablet computers are wirelessly connected to communication networks associated with the system. Generally, multimedia content will be generated by third parties and stored on a number of different servers, as illustrated in FIG. 1 and accessible via the Internet (denoted by reference numeral 100). Reference numerals 110, 120 and 130 each indicate an at least one server. In FIG. 1, the server 110 represents one or more servers to store print media in digital form (for example, magazines are a form of print media. The publisher of a print magazine will generate the digital forms of their magazines and store them on their servers, wherein different publishers are likely to save their contents on different servers). The server 120 represents one or more servers for storing television (TV) programs in digital form, wherein different TV programs are likely to be hosted on different servers 120. The server 130 represents one or more servers for storing movies in digital form. Each of the at least one servers 110, 120 and 130 is connected to the Internet via a physical and logical connection (115, 125, 135, respectively). For example, the physical connectivity aspect of each connection 115, 125, 135 can be implemented by means of routers, optical fibres, cables, and wireless access points. The logical connectivity aspect of each connection 115, 125, 135 can be implemented by stacks of communication protocols, namely, medium access control (MAC) protocol, link layer protocols, Internet Protocol (IP), Transport Control Protocol (TCP), User Datagram Protocol (UDP), and Hypertext Transfer Protocol (HTTP). A train infotainment server (TIS) 200 is connected to the Internet 100 via a connection 205, and through this connection, the TIS 200 is in network communication with each of the at least one servers 110, 120, 130. A processor (not shown) operatively connected to the TIS 200 for controlling operation of the TIS 200 and downloading content from each of the at least one servers 110, 120, 130 (or any of them) onto the TIS 200 and saves the content on local storage devices. The TIS 200 initiates communication with the passenger devices. The multimedia content servers 110, 120, 130 and the TIS 200 can be physically located in different geographic locations, but all such servers 110, 120, 130 and 200 are connected to the Internet 100. Note that one can easily add multimedia content servers in addition to those servers 110, 120, 130 indicated in FIG. 1.

As outlined above, multiple media supply servers 110, 120, 130 store different kinds of multimedia content to be accessed by train passengers. Although a single server can store different classes of content, for reasons of ownership, security, performance, and access control, different classes of multimedia content, each associated with a different owner and/or distributor, will be stored on different servers. Multimedia content from each of the at least one servers 110, 120, 130 is downloaded onto the train infotainment server (TIS) 200 and saved for dissemination to passenger devices.

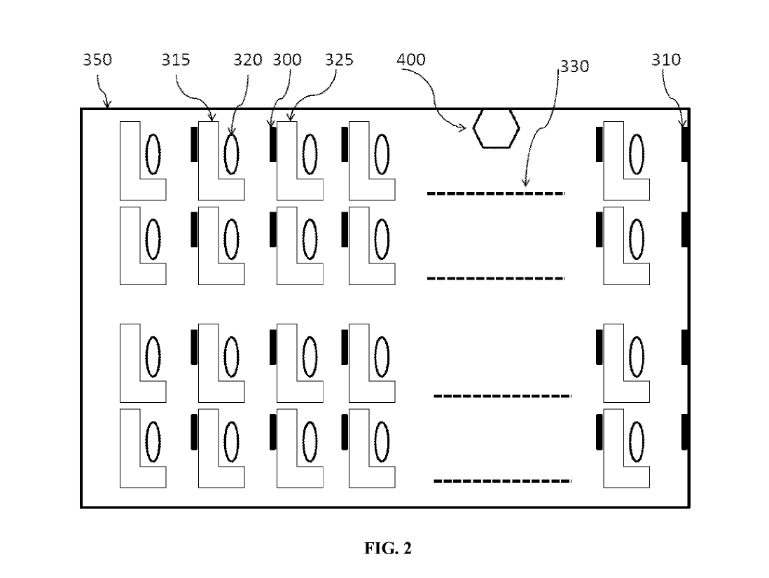

FIG. 2 depicts a plurality of passenger devices 300 and an on-board server (OBS) 400. The passenger devices 300 are computing devices, namely computer appliances having a memory for accommodating a desired media volume and configured to function as a personal computer, and could include for example a tablet computer, smart phone or similar such device. Optionally, each passenger device 300 is mounted on the back of each seat 315, 325 within each train car 350 (wherein seat 325 represents another car seat in front of seat 315), such that there are a multitude of devices in each train car 350. Every passenger device 300 is in network communication with the on-board server 400 in each car. The passenger devices 300 may take the form of general purpose tablet computers with a touch screen, a solid state disk (commonly known as flash memory), and one or more wireless communication interfaces.

Each OBS 400 is adapted for wireless connection, for example, to the wireless local area network (WLAN) associated with each train car 350. In addition, at stations, each OBS 400 can be connected to the WLANs associated with the train stations themselves and/or station platforms. Each passenger device 300 of a train car 350 connects with that train car's OBS 400 via the WLAN of the train, and the OBS 400 and its associated passenger devices 300 can obtain their Internet Protocol (IP) addresses from standard DHCP (Dynamic Host Configuration Protocol) servers accessible via the WLANs.

Media files from each OBS 400 can be delivered to the passenger devices 300 associated therewith by means of a new application-layer protocol running on top of the standard UDP (User Datagram Protocol) transport protocol by utilizing the multicast capability of the Internet via the Internet Group Management Protocol (IGMP) mechanism. Here the main idea is to reduce the number of transmissions performed by the wireless access points connected to the WLANs of trains while each OBS 400 pushes media files on to the passenger devices 300.

Media files from the train infotainment server (TIS) 200 can be pushed onto the on board server 400 by means of: (i) the commonly used FTP (File Transfer Protocol) protocol; or (ii) a new application-layer protocol running on top of the standard UDP (User Datagram Protocol) transport protocol by utilizing the multicast capability of the Internet via its IGMP (Internet Group Management Protocol) mechanism. Using the FTP protocol to transfer files from the TIS 200 to each OBS 400 will make software development faster. However, a new application-layer protocol running on top of the standard UDP protocol to transfer media files from the TIS 200 to each OBS 400 can make file transfer faster because the application-layer protocol can take advantage of the multicast capability of the Internet. If there is a small number of OBS servers 400, one can choose the FTP option, whereas the UDP option will be the better performing one for a large number of OBS servers 400 on a train.

In a preferred embodiment, each such passenger device 300 contains an integrated credit card chip reader to be utilized when a user 320 chooses to purchase multimedia content, access the Internet, or utilize any other paid service that from time to time becomes available. Additionally, each passenger device 300 is preferably programmed with secure payment processing system/software. Other payment means could be employed, such as requiring the user to key in his or her credit card number on the touch screen. It is anticipated that in most installations, the user 320 will be provided with at least a quantity of free content, as an enticement, and some content (movies, for example) requiring payment. Some passenger devices may be mounted on the walls of the train car 350, and such devices are labelled 310, as shown in FIG. 2. Though we have labelled one component as 310, there may be many passenger devices of type 310 in each car 350. No distinction will be made between a component of type 300 and a component of type 310, and such components will simply be referred to by reference number 300. The line indicated at reference numeral 330 denotes the continuation of a row of seats, passengers, and passenger devices of the car 350.

The OBS 400 communicates with all of the passenger devices 300. In general, each car 350 has an OBS 400, if there are passenger devices 300 installed in the car 350. The OBS 400 is, for example, a computer with a solid state disk (commonly known as flash memory) and one or more wireless communication interfaces. Standard input and output devices, such as a monitor and a keyboard, can be optionally connected to the OBS 400. The rationale for including an OBS 400 in each car 350 is as follows: Because a central principle of the invention is to save media content on each passenger device 300 and the amount of such content is in the range of gigabytes, an on-board server 400 will make the process of saving content on each passenger device 300 faster. All the OBSs 400 simultaneously communicate with the passenger devices 300 in their respective cars 350. Moreover, because the concentration of passenger devices 300 in each car will be very high (something around 70 per car in a standard car), broadcasting a large amount of data to all of those devices 300 in a small area will be a challenging task at the communication software level, owing to packet loss. Keeping an OBS 400 in each car 350 will mitigate this problem. Each OBS 400 will monitor and record the operational status of each associated passenger device 300 in the car 350, and report the data to the processor (not shown) in communication with the TIS 200, from time to time.

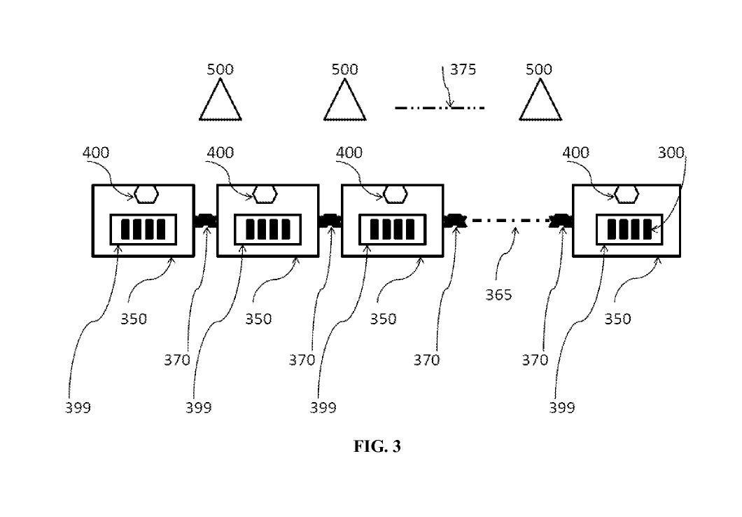

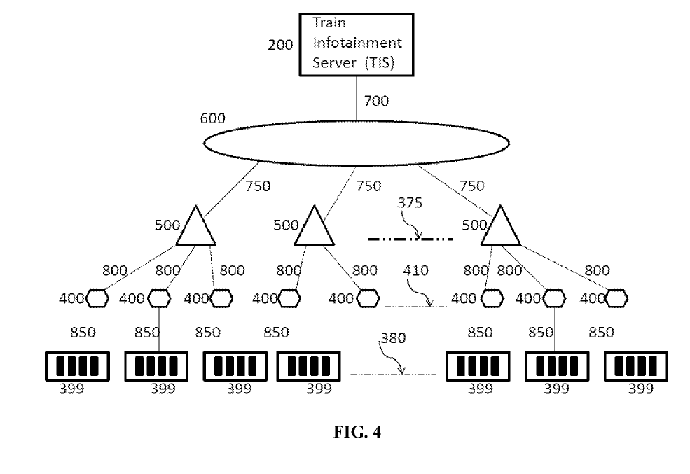

Each passenger 320 seated in each seat 315 uses the device 300 mounted on the back of the seat 325 to access multimedia content saved on the device 300. FIG. 2 depicts the scenario that a train car is fitted with tens of seats and, therefore, there are tens of passenger devices in each car. By means of FIG. 3 and FIG. 4, the process for delivering multimedia content to the passenger devices is explained.

The relationships among many cars of a train, the passenger devices in the cars, the on-board server (OBS) in cars, and train-side servers (TSS) is illustrated in FIG. 3. The components of FIG. 3 are described as follows: Reference numeral 365 represents a sequence of adjacent train cars 350 mechanically connected by components of type 370. The set of all passenger devices found in each train car 350 is denoted by reference numeral 399, and reference numeral 500 indicates an at least one train-side server (TSS). Each TSS 500 is positioned in proximity to the train track (or route, or way on land, in the case of vehicles other than trains) and is operatively connected with the OBS 400 for communicating over a wireless interface, such as WiFi. The TSS 500 represents a general purpose, high speed server. Reference numeral 375 represents the continuation of a set of TSS 500. Each TSS 500 is capable of serving as a file repository for holding copies of media files (i.e. content) downloaded from the TIS 200. In comparison with the TIS 200, the TSS 500 entities are physically nearer to the OBS servers 400. By virtue of this close proximity, copying media files from TSS 500 entities to OBS entities 400 will generally be faster than copying media files direct from the TIS 200 to the respective OBS 400. In this way, each TSS server functions to enhance the overall performance of the system. Note, however, that where file transfer time from TIS 200 to OBS 400 is expected to be reasonably low (for example, by virtue of the nature of the media files to be transferred, or other factors) then the utility of the TSS servers 500 within the system is diminished.

Referring next to FIG. 4, a communication infrastructure for enabling communication between each set of passenger devices 399 and the TIS 200 by means of the TSS 500 and OBS 400 is shown. A communication network 600 interconnects the TIS 200 with each TSS 500. The communication network 600 can be implemented in several ways, including, but not limited to, as a local area network (LAN), a wireless local area network (WLAN), a combination of LANs and WLANs connected by general purpose routers, and a mesh network of WiFi access points. The connection point 700 between the network 600 and the TIS 200 can be wired or wireless, and implemented in several ways depending on network 600 parameters. Similar connection points 750 are used to link the network 600 to each TSS 500. As previously indicated, each TSS 500 is operatively connected with the OBS 400 for communicating over a wireless interface, such as WiFi. The continuation of the set of OBS components 400 is represented by the broken line at reference numeral 410.

Still referring to FIG. 4, a series of wireless communication links 800 enable communication and transmission of data between respective TSS servers 500 and OBS servers 400. As such, each TSS 500 and paired OBS 400 should have compatible radio interfaces. For example, both types of components may have WiFi interfaces running the IEEE 802.11n protocol. It is important to note that one component of server type 500 can be simultaneously connected to many components of server type 400, in a one-to-many configuration, to take advantage of the broadcast and multicast operations available at medium access control (MAC) protocol level. Broadcast and multicast operations will enable the simultaneous dissemination of multimedia contents, thereby reducing the time for content dissemination to the passenger devices. A wireless link 850 connects each OBS 400 to the each of the at least one passenger devices 300 contained in a given set 399. As such, each OBS 400 and its paired passenger devices 300 should have compatible radio interfaces. For example, both of components 300 and 400 can have WiFi interfaces running the IEEE 802.11n protocol. It is important to note that one component of server type 400 can be simultaneously connected to components of type 300 contained in the same component 399, in a one-to-many and one-to-all configuration, in order to take advantage of the broadcast and multicast operations available at medium access control (MAC) protocol level. Broadcast and multicast operations will enable the simultaneous dissemination of multimedia content, thereby reducing the time for content dissemination to each passenger device 300. The broken line indicated at reference numeral 380 denotes that the system can function with a plurality of sets of passenger devices 399.

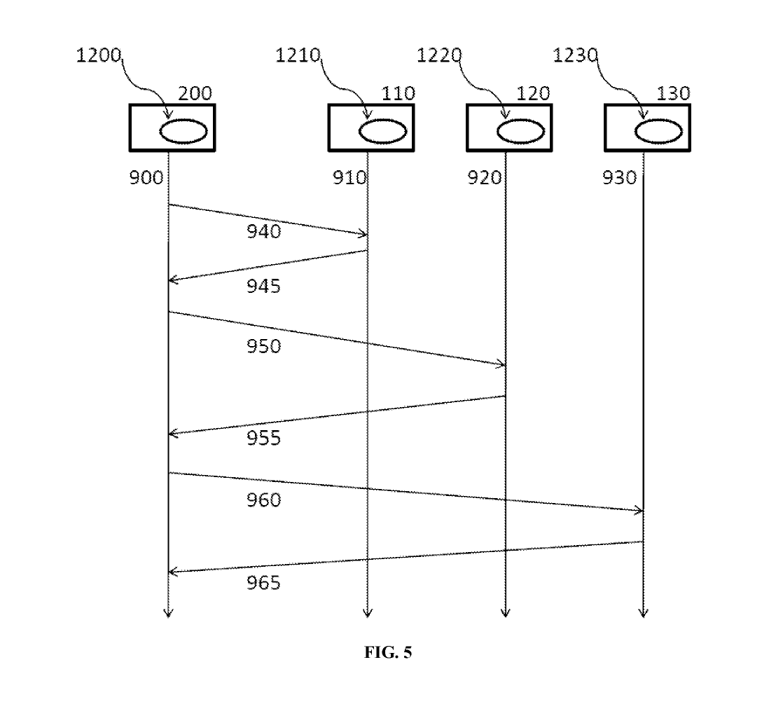

FIG. 5 depicts the interactions of the TIS 200 with each of the at least one media servers 110, 120, 130 in the form of a message sequence chart, wherein reference numeral 900 represents the passage of time for the TIS 200, and 910, 920, and 930 represent the passage of time for each of the multimedia content servers 110, 120 and 130, respectively. Time passes in the direction of each arrow. Reference numerals 1200, 1210, 1220 and 1230 denote processors coupled with component servers 200, 110, 120, 130, respectively, each such processor holding a program for facilitating the transmission of content to and from each server in response to a request.

In FIG. 5, reference numeral 940 represents a request message from component 1200 to component 1210. By means of this message, component 1200 can request component 1210 to send a specific media file in one or more smaller packets. In general, component 940 embodies a class of many messages for communication between the two components. Reference numeral 945 represents a message from component 1210 to component 1200 in response to a message of type 940. For example, component 945 can represent a smaller chunk of the file requested in a message of type 940. Reference numeral 950 represents a request message from component 1200 to component 1220. By means of this message, component 1200 can request component 1220 to send a specific media file in one or more smaller packets. In general, component 950 embodies a class of many messages for communication between the two components. Reference numeral 955 represents a message from component 1220 to component 1200 in response to a message of type 950. For example, component 955 can represent a smaller portion of the file requested in a message of type 950. Reference numeral 960 represents a request message from component 1200 to component 1230. By means of this message, component 1200 can request component 1230 to send a specific media file in one or more smaller packets. In general, component 960 embodies a class of many messages for communication between the two components. Still referring to FIG. 5, reference numeral 965 represents a message from component 1230 to component 1200 in response to a message of type 960. For example, component 965 can represent a smaller chunk of the file requested in a message of type 960.

Note that it is possible to define a general format for the messages of type 940, 950, and 960, and another general format for the response messages of type 945, 955, and 965. Components 1200 and 1210 exchange several messages of types 940 and 945 for component 1200 to download one or multiple media files. The component pair 1200 and 1220 can exchange several messages of type 950 and 955 for component 1200 to download one or multiple media files. Similarly, the component pair 1200 and 1230 can exchange several messages of type 960 and 965 for component 1200 to download one or multiple media files. By means of the message sequence chart depicted in FIG. 5, component 1200 can download media files from media server processes, namely 1210, 1220, and 1230, and save copies of those files on the storage media (not shown) associated with the TIS 200.

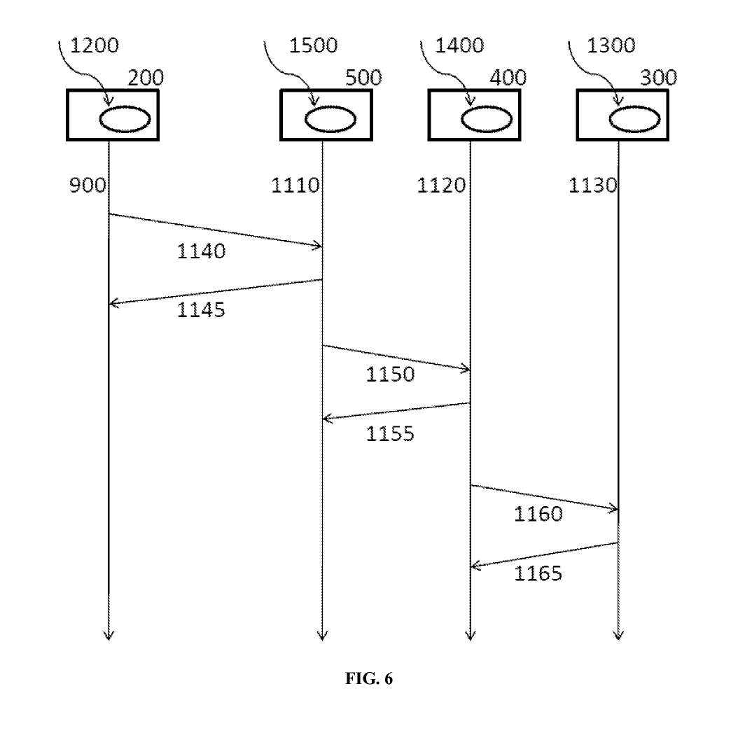

FIG. 6 illustrates the interactions among the TIS 200, TSS 500 and OBS 400 servers, and passenger devices 300 in the form of a message sequence chart where reference numeral 1110 represents the passage of time for each TSS 500. Time passes in the direction of the arrow on component 1110. Reference numeral 1120 represents the passage of time for each OBS 400. Time passes in the direction of the arrow on component 1120. Reference numeral 1130 represents the passage of time for each passenger device 300. Time passes in the direction of the arrow on component 1130. Reference numerals 1300, 1400 and 1500 each denote processors coupled with each of the component passenger devices 300, OBS servers 400 and TSS servers 500, respectively, each such processor holding a program for facilitating the transmission of content to and from each server in response to a request. In FIG. 6, the line at reference numeral 1140 represents the flow of data and control messages to copy a media file from component 200 (TIS) to component 500 (TSS server). These packets are initiated by the processor 1200.

Still referring to FIG. 6, the line at reference number 1145 represents acknowledgements and replies sent by component processor 1500 to component processor 1200 in response to messages of type 1140. The line denoted by reference number 1150 represents the flow of data and control messages to copy a media file from the TSS 500 to the associated OBS 400. These packets are initiated by the component processor 1500. The line at reference numeral 1155 represents acknowledgements and replies sent by component processor 1400 to component processor 1500 in response to messages of type 1150.

Still referring to FIG. 6, the line at reference number 1160 represents the flow of data and control messages to copy a media file from the OBS 400 to the associated passenger device(s) 300. These packets are initiated by the processor 1400. The line indicated at reference numeral 1165 represents acknowledgements and replies sent by component processor 1300 to component processor 1400 in response to messages of type 1150.

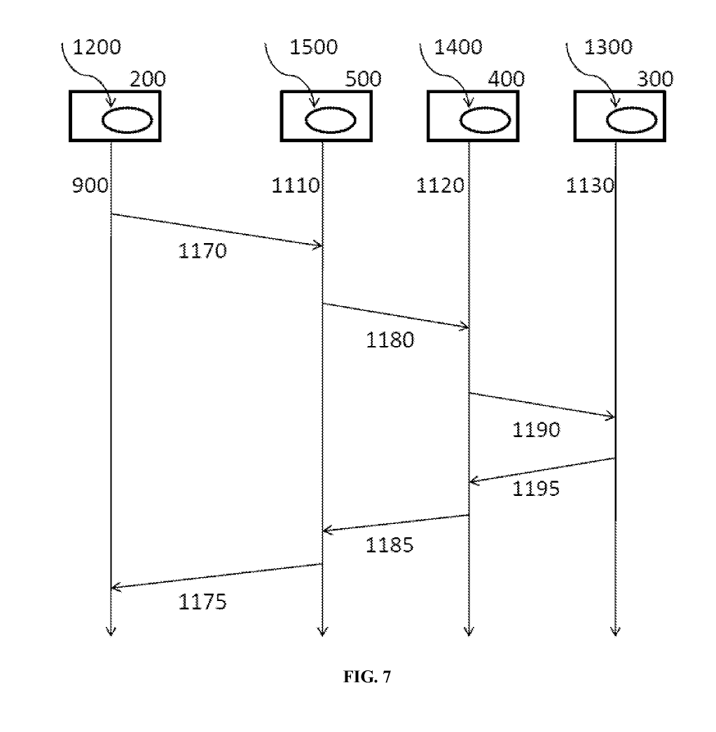

FIG. 7 depicts a scenario of management of passenger devices in accordance with the system of the present invention. In the following passages, the additional functions of component processors 1200, 1500, 1400, and 1300 are explained by means of the following additional components: 1170: This is an inquiry message sent from processor 1200 to processor 1500 to inquire re: the status of the associated passenger device 300; 1180: This is an inquiry message sent from processor 1500 to processor 1400 to inquire re: the status of the associated passenger device 300; 1190: This is an inquiry message sent from processor 1400 to processor 1300 to inquire re: the status of the associated passenger device 300; 1195: This is a response message sent from processor 1300 to processor 1400 to inquire re: the status of the associated passenger device 300; 1185: This is a response message sent from processor 1400 to processor 1500 to inquire re: the status of the associated passenger device 300; 1175: This is a response message sent from processor 1500 to processor 1200 to inquire re: the status of the associated passenger device 300.

Note that FIG. 7 illustrates just one way to query the status of a passenger device. FIG. 7 can be readily modified so that processor 1400 and OBS 400 initiate an inquiry process, gather the status of all passenger devices 300, and send them to processor 1200 by means of a pull mode of communication or a push mode.

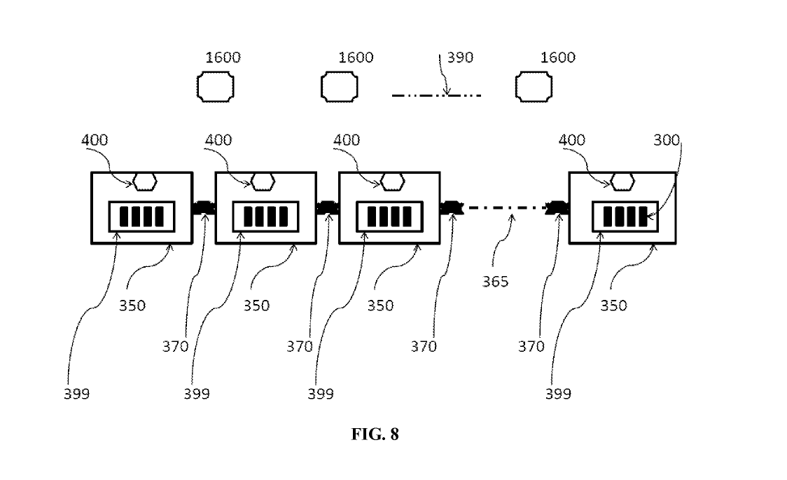

The relationships among many cars of a train, the passenger devices in the cars, the on-board server (OBS) in cars, and track-side access points are illustrated in FIG. 8 wherein each reference numeral 1600 represents one wireless access point located near the train tracks outside the cars of the trains, and reference numeral 390 represents a series of such wireless access points for facilitating communication between OBS 400 servers and TIS servers 200 (or, where employed in the system, TSS servers 500). Such components 1600 and 390 are termed track-side access points (TSAP or TSAP points). Each TSAP 1600 could be located near the train tracks, or on or near train station platforms. The communication range of a TSAP is determined by the specific wireless communication technology supported by the TSAP components. The component 390 represents the continuation of a set of TSAP 1600. The separation distance between two TSAPs is determined by their communication ranges and the need to provide continuous communication between each OBS 400 and each associated TSAP 1600. Here, continuous communication means that each OBS 400 is within the communication range of each associated TSAP 1600. Therefore, as a train moves, each OBS 400 remains within the communication range of one or more TSAP points 1600. Moreover, as the train moves, a wireless connectivity of a given OBS 400 with each associated TSAP 1600 keep changing, because the train is moving, whereas all TSAP points 1600 are static. TSAPs 1600, themselves, can communicate in a wired (e.g. fibre optics) or wireless manner, and all such TSAPs 1600 are connected to the Internet.

While a train is moving, a passenger device 300 can connect to the Internet via the local car's on-board server 400 and a nearby track-side access point (TSAP) 1600. Having Internet connectivity for passenger devices on a moving train can be used to support on-line payment. For example, passengers can access the multimedia services available on seatback mounted devices in one of the following ways: If a passenger can physically access a device, then the multimedia services available on the device are automatically accessible to the passenger; or, even if a passenger can physically access a device, access to the multimedia services on the device is not automatic. Instead, the passenger makes a payment through the device to be able to access the services. On-line payments can be implemented in several ways, including credit card payment, which will require the passenger device to communicate with the Internet via the local OBS component 400 and a nearby TSAP component 1600.

With reference to the system designs identified in FIGS. 5-7, and as described above, interactions among components of type 300, 400, 1600, and a server on the Internet (e.g. 200) can readily designed.

Components of type 200, 500, 400, 1600, and 300 can be powered from a local battery and the mains. It will be more common to power components of type 200, 500, and 1600 from the mains, because those are static components and it is easy to power them. On the other hand, components of type 300 and 400 will have their own rechargeable batteries connected to the mains. If the mains is switched off, components of type 300 and 400 will run on their local batteries. For example, it is not always necessary to switch on the mains of a train to enable communication between components of type 300 and 400. When power is restored to the mains of a train, the local batteries of components of type 300 and 400 continue to recharge. The lifetime of the batteries, that is the lengths of time the batteries can power components of type 300 and 400, are determined based on the tasks the devices are expected to perform even while the mains of a train is switched off.

While one or more embodiments of this invention have been illustrated in the accompanying drawings and described above, it will be evident to those skilled in the art that changes and modifications can be made therein without departing from the essence of this invention. All such modifications are believed to be within the sphere and scope of the invention as defined by the claims appended hereto.

What is claimed is:

1. An infotainment system for use by a user in a vehicle, comprising a plurality of individual computing devices, each computing device having sufficient memory to accommodate a desired media volume, and further comprising, an at least one server for downloading media content to the individual computing devices, whereby the user at each computer device may view individually-selected media according to the user's own preferences and timetable, without need for streaming from a central server.

2. A system as in claim 1, wherein there is at least one said server on board the vehicle.

3. A system as in claim 2, wherein there is at least one server outside the vehicle, for periodic downloading of media content to the at least one server on board the vehicle via a wireless connection.

4. A system as in claim 3, wherein the server outside the vehicle connects to a plurality of media supply servers via the Internet, to acquire said media content for the system.

5. A system as in claim 4, wherein the server outside the vehicle is operatively connected to a processor for controlling the transfer of media content to the server on board the vehicle.

6. A system as in claim 3, wherein the at least one server outside the vehicle is disposed in close proximity to the at least one server on board the vehicle.

7. A system as in claim 6, wherein the at least one server outside the vehicle is disposed in a fixed position along a vehicle route.

8. A system of claim 6, wherein the at least one server outside the vehicle is operatively connected to the at least one server on board the vehicle for communicating over a wireless interface.

9. A system as in claim 1, wherein each of the plurality of individual computing devices is in network communication with the at least one server.

10. A system as in claim 2, wherein the server on board the vehicle is wirelessly connected to the plurality of individual computing devices.

11. A system as in claim 4, further comprising an at least one wireless access point for facilitating communication between the server on board the vehicle and the plurality of media supply servers.

12. A system as in claim 4, wherein the media content is pushed from each of the plurality of media supply servers to the at least one server on board the vehicle by file transfer protocol.

13. A system as in claim 4, wherein the at least one server outside the vehicle serves as a file repository for storing copies of the media content received from the plurality of media supply servers, for later transmission to the at least one server on board the vehicle.

14. A system as in claim 1, wherein each of the plurality of media supply servers holds a different set of media.

15. A system as in claim 1, wherein the vehicle is a train car of a passenger train.

16. The system as in claim 9, wherein the passenger train comprises a plurality of train cars.

17. A system as in claim 10, wherein train car each of the plurality of train cars contains at least one server.

18. A system as in claim 1, wherein the plurality of individual computing devices are a plurality of tablet computers.
